(19) United States
(12) Patent Application Publication
(10) Pub. No.: US 2023/0255727 A1
(43) Pub. Date: Aug. 17, 2023

(54) ORTHODONTIC APPLIANCE ASSEMBLIES AND METHODS OF USE

(71) Applicant: Braces On Demand, Inc., Hicksville, NY (US)

(72) Inventors: Colin James Corey, Carlsbad, CA (US); Ammar Ahmed Syed, Unionville (CA); Thomas Patrick Shannon, Byron Center, MI (US)

(21) Appl. No.: 18/105,388

(22) Filed: Feb. 3, 2023

Related U.S. Application Data
(60) Provisional application No. 63/309,356, filed on Feb. 11, 2022.

(51) Int. Cl. A61C 7/00; A61C 13/34; A61C 7/28

(52) U.S. Cl. CPC A61C 7/002; A61C 7/28; A61C 13/34

(57) ABSTRACT

In some embodiments, apparatuses and methods are provided herein useful to orthodontic appliance assemblies. In some embodiments, an orthodontic appliance assembly comprises a plurality of orthodontic appliances, wherein each of the plurality of orthodontic appliances includes an archwire slot, and wherein each of the plurality of orthodontic appliances is configured to be bonded to a tooth in a patient’s mouth, an archwire, wherein the plurality of orthodontic appliances are retained on the archwire via the archwire slots, wherein the plurality of orthodontic appliances are retained on the archwire before the orthodontic appliances are bonded to teeth in the patient’s mouth.

### TECHNICAL FIELD

This invention relates generally to orthodontics and, more specifically, orthodontic appliances.

### BACKGROUND

Orthodontic clinicians seek to correct malocclusions by use of many different devices, such as braces, retainers, palate expanders, positioners, etc. Braces, one of the most commonly used appliances, include brackets, archwires, and ligatures. Because no two patients have identical malocclusions or facial geometries, the prescription for each patient’s braces must be selected by the clinician. While there exist a large number of bracket types and bracket geometries, selecting from the available brackets is simply selecting the closest available bracket for the patient’s malocclusions and facial geometry. That is, there is a limited world of choices for brackets (and orthodontic appliances generally), and clinicians must select the best-fit option for the limited world of choices. It should come as no surprise that, while a large variety of brackets are available, it would be beneficial to have custom brackets for each patient. Accordingly, if a clinician could create a custom bracket based on the patient’s malocclusions and facial geometry, it would often be superior to selecting the closest fit from the available brackets. A need therefore exists for custom brackets (or other orthodontic appliances) that can be designed specifically for a patient’s malocclusions and facial geometry.

During treatment, brackets are affixed to a patient’s teeth and the archwire passes through slots in the brackets designed to receive the archwire. The ligatures secure the archwire within the slots. Traditionally, the brackets are affixed to the patient’s teeth before the archwire is placed into the archwire slots and secured via the ligatures. This traditional installation technique, however, has limitations. For example, as the brackets exist independently of one another, it is possible to secure the wrong bracket to a patient’s tooth (e.g., select the wrong bracket for the patient’s tooth). Additionally, bonding brackets and installing the archwire can be a time intensive step in the orthodontic process. Accordingly, a need exists for systems and methods which increase the ease with which brackets can be secured to a patient’s teeth and ensure the correctness of each bracket position.

### BRIEF DESCRIPTION OF THE DRAWINGS

Disclosed herein are embodiments of systems, apparatuses, and methods pertaining to orthodontic appliance assemblies. This description includes drawings, wherein:

FIGS. 1A - 1C depict perspective, bottom, and front views, respectively, of a model 100 of a patient’s mouth when the patient’s teeth 102 are in initial tooth positions, according to some embodiments;

FIGS. 2A - 2C depict perspective, bottom, and front views, respectively, of a model 200 of a patient’s mouth when the patient’s teeth 202 are in final tooth positions, according to some embodiments;

FIG. 3 depicts a positional relationship between a tooth 302 and a tip angle 322, according to some embodiments;

FIG. 4 depicts a positional relationship between a tooth 402 and a torque angle 418, according to some embodiments;

FIG. 5 depicts a positional relationship between a tooth 502 and an offset angle 518, according to some embodiments;

FIG. 6 depicts a positional relationship between a tooth 602 and an in/out distance 618, according to some embodiments;

FIG. 7 depicts determination of multiple base radii of a tooth 702, according to some embodiments;

FIG. 8 depicts a patients tooth 802 in an initial tooth position 804 and a final tooth position 806, according to some embodiments;

FIG. 9A depicts an archwire 908 actively interacting with an archwire slot 906 of an orthodontic appliance 902, according to some embodiments;

FIG. 9B depicts an archwire 908 passively interacting with an archwire slot 906 of an orthodontic appliance 902, according to some embodiments;

FIG. 10 is a first flowchart depicting example operations for creating an orthodontic appliance, according to some embodiments;

FIG. 11 is a second flowchart depicting example operations for creating an orthodontic appliance, according to some embodiments;

FIG. 12A depicts a dentition 1210 of a patient and an orthodontic appliance assembly 1200, according to some embodiments;

FIG. 12B depicts a dentition 1210 of a patient with an orthodontic appliance assembly 1200 secured to teeth 1202 of the patient’s dentition, according to some embodiments;

FIGS. 13A and 13B are perspective and top views, respectively, of an orthodontic appliance assembly 1300, according to some embodiments;

FIGS. 14A and 14B are exploded facial and lingual views, respectively, of an orthodontic appliance assembly, according to some embodiments;

FIG. 15A is a perspective view, and FIG. 15B is an exploded perspective view, of an orthodontic appliance assembly 1500 including an archwire 1502 featuring a bend, according to some embodiments;

FIG. 16A is a perspective view of an orthodontic appliance assembly 1602 and a bonding tray 1604, according to some embodiments;

FIG. 16B is a perspective view of the orthodontic appliance assembly 1602 of FIG. 16A inserted into the bonding tray 1604, according to some embodiments;

FIG. 17 is a flowchart depicting example operations for manufacturing an orthodontic appliance assembly, according to some embodiments;

FIG. 18 is a flowchart depicting example operations for assembling an orthodontic appliance assembly, according to some embodiments;

FIG. 19 is a block diagram of a system 1900 for additively manufacturing orthodontic appliances, according to some embodiments; and

FIG. 20 is a block diagram of a system 2000 that may be used for implementing any of the components, circuits, circuitry, systems, functionality, apparatuses, processes, or devices of the system 1900 of FIG. 19, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to orthodontic appliance assemblies In some embodiments, an orthodontic appliance assembly comprises a plurality of orthodontic appliances, wherein each of the plurality of orthodontic appliances includes an archwire slot, and wherein each of the plurality of orthodontic appliances is configured to be bonded to a tooth in a patient’s mouth, an archwire, wherein the plurality of orthodontic appliances are retained on the archwire via the archwire slots, wherein the plurality of orthodontic appliances are retained on the archwire before the orthodontic appliances are bonded to teeth in the patient’s mouth.

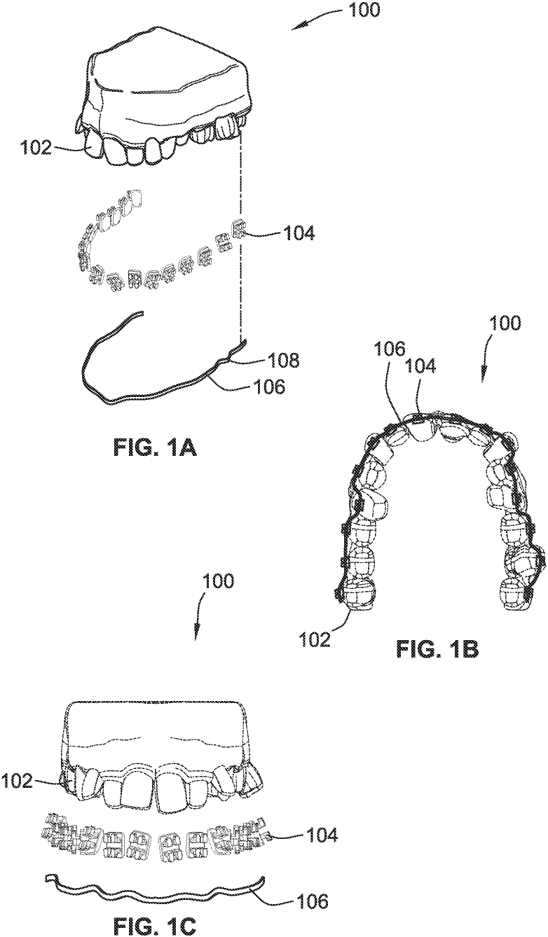

As previously noted, no two patients have identical malocclusions and/or facial geometries. Accordingly, though a large number of orthodontic appliances exist, picking from existing orthodontic appliances is simply selecting the “best fit” orthodontic appliance for a patient. Though selection from existing orthodontic appliances allows clinicians to treat patients’ malocclusions, the selected appliances aren’t designed for each specific patient, and thus are not tailored to the patient’s malocclusions or facial geometry. While techniques exist for creating partially custom brackets, these techniques typically focus on a base (as opposed to a body) of the orthodontic appliance. For example, the partially custom orthodontic appliances may have bases designed specifically for a patient, but the body of the bracket remains the same between patients. Described herein are systems, methods, and apparatuses that seek to minimize, if not eliminate, the drawbacks of the currently available orthodontic appliances. For example, in some embodiments, the systems, methods, and apparatuses described herein can be used to create custom orthodontic appliances for patients. The custom orthodontic appliances are designed based on the patient’s facial geometry and/or malocclusions and final tooth positions for the patient such that when the teeth are in their final tooth positions, an archwire interacts passively with the orthodontic appliances. The custom orthodontic appliances can be custom in that the body of the orthodontic appliance is custom (e.g., with a generic base), the base of the orthodontic appliance can be custom, or both the body and the base of the orthodontic appliance can be custom. The discussion of FIGS. 1 - 11 provide additional detail regarding such custom orthodontic appliances.

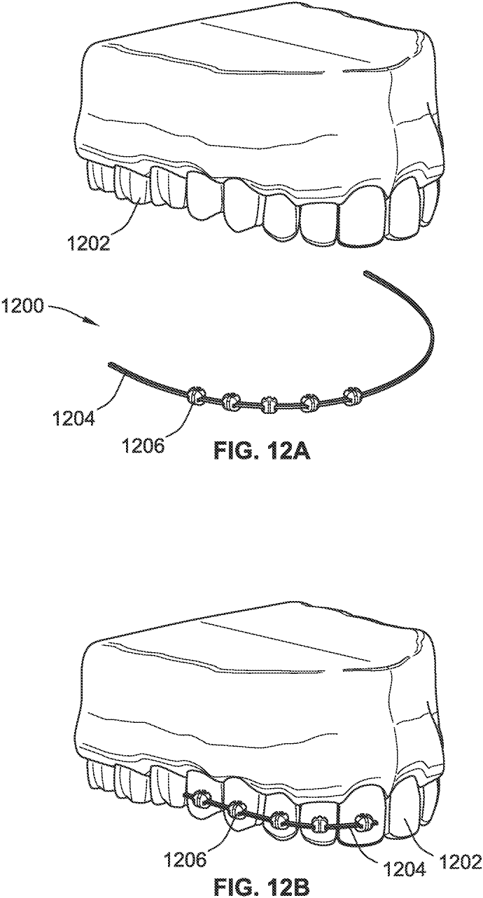

Further, as previously noted, braces are a common orthodontic appliance used to correct malocclusions of a patient’s teeth. Typically, braces include brackets, archwire, and ligatures, though it should be noted that some brackets do not utilize ligatures to secure the archwire within the archwire slot. Traditionally, braces are installed in a patient’s mouth by first affixing the brackets to the patient’s teeth. Once the brackets are affixed to the patient’s teeth, the archwire is placed, and subsequently secured (e.g., via the ligatures), in the archwire slots of the brackets. As previously discussed, this installation scheme can be error-prone and difficult. For example, because the brackets are independent of one another, it can be difficult to ensure that the correct bracket is selected for each tooth and that the brackets are affixed in the patient’s mouth in the correct order. Additionally, this installation scheme presents challenges, as the brackets are physically small and thus difficult to manipulate, and hold, for proper placement on the tooth. Described herein are systems, methods, and apparatuses that seek to minimize, if not eliminate, the drawbacks of the traditional installation techniques. For example, in one embedment, an orthodontic appliance assembly is disclosed. The orthodontic appliance assembly includes a plurality of orthodontic appliances and an archwire. In some embodiments, the archwire is installed in archwire slots of the orthodontic appliances before the orthodontic appliances are affixed (e.g., secured) to the patient’s teeth. That is, the orthodontic appliance assembly is assembled before the orthodontic appliance assembly is placed in the user’s mouth (e.g., by securing the orthodontic appliances to the patient’s teeth). In such embodiments, the orthodontic appliances may be retained on the archwire before the orthodontic appliance assembly is placed in the patient’s mouth. Because the orthodontic appliance assembly is assembled before it is placed in the patient’s mouth, the likelihood that the correct orthodontic appliances are used, as well as the orthodontic appliances are in the correct order, is increased. Additionally, the time required for installation or orthodontic appliances can be decreased. The discussion of FIGS. 12 - 20 provides additional detail regarding such an orthodontic appliance assembly.

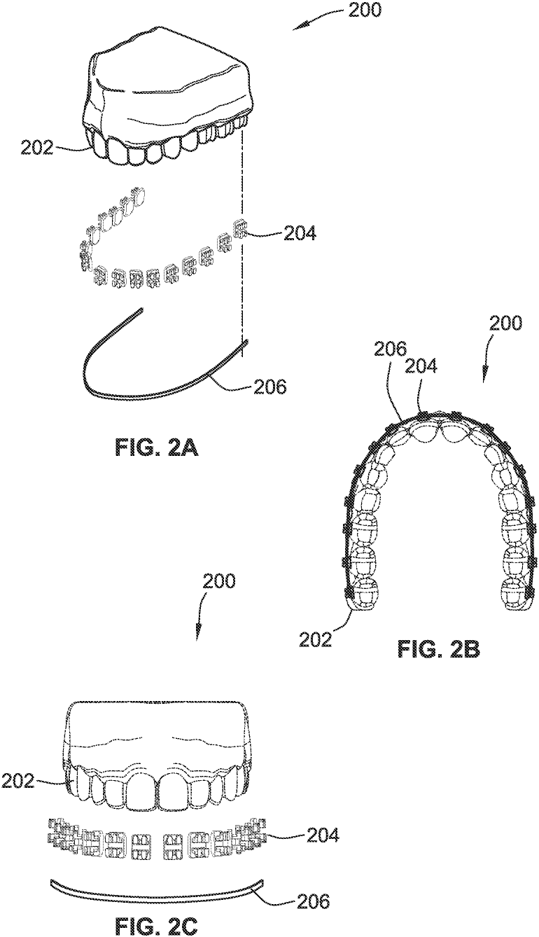

FIGS. 1A - 1C depict perspective, bottom, and front views, respectively, of a model 100 of a patient’s mouth when the patient’s teeth 102 are in initial tooth positions, according to some embodiments. As shown in the model 100 of the patient’s mouth depicted in FIGS. 1A - 1C, the patient’s mouth includes a number of malocclusions, as indicated by the patient’s teeth 102 not presenting as a smooth archform (as shown, for example, in FIGS. 2A -2C). Orthodontic appliances 104, such as brackets, are secured to the patient’s teeth 102 and an archwire 106 passes through archwire slots of the orthodontic appliances 104 during treatment, as depicted in FIG. 1B. Because the patient’s mouth features malocclusions, the archwire 106 is deformed (e.g., bent) when it passes through the archwire slots, as indicated by the exemplary bend 108 in the archwire 106. In some embodiments, one or more of the orthodontic appliances 104 are custom made for the patient based, in part, on the initial tooth positions depicted in the model 100 of the patient’s mouth.

FIGS. 2A - 2C depict perspective, bottom, and front views, respectively, of a model 200 of a patient’s mouth when the patient’s teeth 202 are in final tooth positions, according to some embodiments. As with FIGS. 1A - 1C, orthodontic appliances 204 are secured to the patient’s teeth 202 and an archwire 206 passes through archwire slots of the orthodontic appliances 204. As noted previously, the teeth 202 depicted in FIGS. 2A - 2C are in their final tooth positions, as indicated by the smooth curvature of the archform of the model 200. In some embodiments, when the teeth 202 are in their final positions, the archwire 206 passively interacts with the archwire slots of one or more of the orthodontic appliances 204. As one example, the archwire can passively interact with the archwire slots of the orthodontic appliances 204 by not exerting a clinically significant force on the orthodontic appliances 204 and/or the patient’s teeth 202.

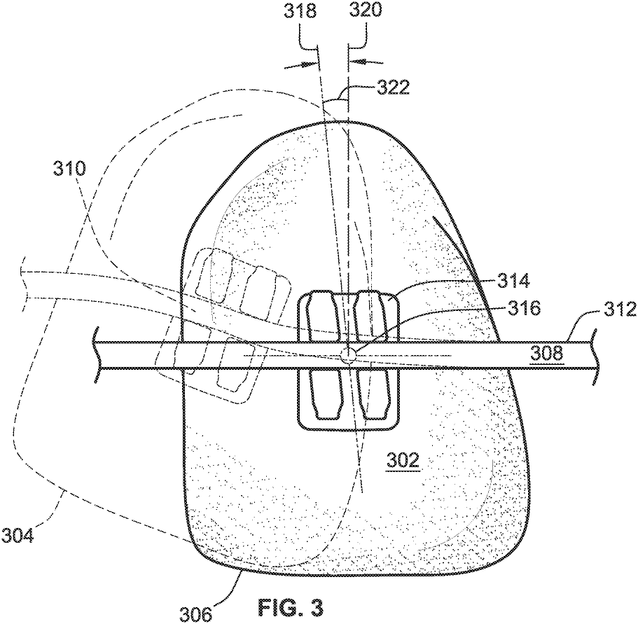

Described herein are systems, methods, and apparatuses that can be used to create custom orthodontic appliances for a patient. In one embodiment, parameters for the custom orthodontic appliances are calculated based on values associated with the patient’s mouth. For example, the values can be associated with final tooth positions, final archforms, geometries of the teeth in the patient’s mouth, slot widths, tip angulations, torque angulations, offset angulations, in-out heights, etc. In one embodiment, the parameters for the orthodontic appliances are calculated such that when the teeth in the patient’s mouth are in their final tooth positions, an archwire passively interacts with the archwire slots of the orthodontic appliances. The discussion of FIGS. 3 - 6 provide additional detail regarding calculating parameters for an orthodontic appliance based on a variety of values associated with the patient’s mouth.

FIG. 3 depicts a positional relationship between a tooth 302 and a tip angle 322, according to some embodiments. For purposes of this discussion, the tip angle 322 is defined as the angle between the tooth crown long axis 318 and a line 320 extending perpendicularly from the archwire 308. FIG. 3 depicts the tooth 302 in two positions: 1) an initial tooth position 304; and 2) a final tooth position 306. The initial tooth position 304 indicates the position of the tooth 302 before treatment (or at the time of calculation of parameters for the orthodontic appliance 314). The final tooth position 306 indicates the desired and/or planned position of the tooth 302 at the completion of treatment (or a current stage of treatment). In FIG. 3, the tooth 302, archwire 312, and orthodontic appliance 314 are shown with dashed lines to indicate the initial tooth position 304 and solid lines to indicate the final tooth position 306. For example, the initial tooth position 304 is the position of the tooth 302 upon which the parameters for the orthodontic appliance 314 are calculated. The goal of treatment is to move the tooth 302 from the initial tooth position 304 to the final tooth position 306.

As can be seen in FIG. 3, the archwire 310 passes through an archwire slot of the orthodontic appliance 314. Because the initial tooth position 304 for the tooth 302 depicted in FIG. 3 is maloccluded, the archwire 312 exhibits a deformation (e.g., a bend 310) as it passes through the archwire slot. That is, the archwire 312 must deform to pass through the archwire slot of the orthodontic appliance 314. Because the archwire 312 is elastic, this deformation causes a force to be applied to the tooth 302 by the archwire 312 via the orthodontic appliance 314. More specifically, the archwire 312 contacts, and applies force to, the boundaries of the archwire slot. When the tooth 302 is in its final tooth position 306, the archwire 312 passes smoothly through the archwire slot of the orthodontic appliance 314 (i.e., the archwire 312 need not deform to pass through the archwire slot of the orthodontic appliance 314). Because the archwire 312 passes through the archwire slot of the orthodontic appliance 314 without deforming when the tooth 302 is in the final tooth position 306, the archwire 312 passively interacts within the archwire slot. Because the interaction between the archwire 312 and the archwire slot is passive when the tooth 302 is in the final tooth position 306, the archwire 312 does not provide sufficient force to move the tooth 302 when the tooth 302 is in the final tooth position 306. To achieve this result, parameters for the orthodontic appliance 314 are calculated such that the archwire 312 passively interacts with the archwire slot of the orthodontic appliance 314 when the tooth 302 is in the final tooth position 306.

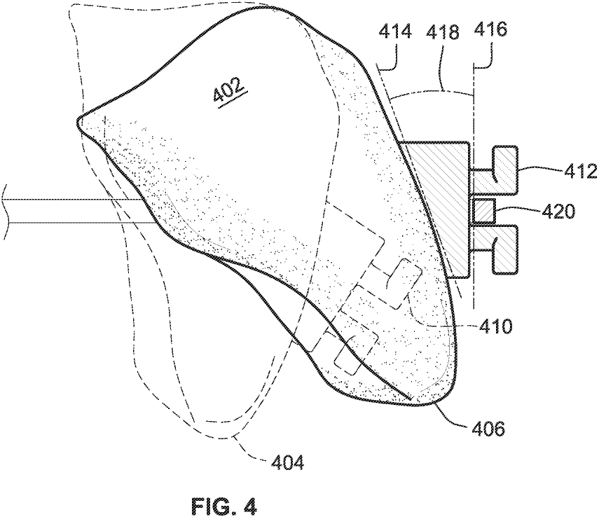

FIG. 4 depicts a positional relationship between a tooth 402 and a torque angle 418, according to some embodiments. For purposes of this discussion, the torque angle 418 is defined as the angle between the tooth plane 414 and the archwire normal plane 416. FIG. 4 depicts the tooth 402 in two positions: 1) an initial tooth position 404; and 2) a final tooth position 406. The initial tooth position 404 indicates the position of the tooth 402 before treatment (or at the time of calculation of parameters for the orthodontic appliance 412). The final tooth position 406 indicates the desired and/or planned position of the tooth 302 at the completion of treatment (or a current stage of treatment). In FIG. 4, the tooth 402 and orthodontic appliance 412 are shown with dashed lines to indicate the initial tooth position 404 and solid lines to indicate the final tooth position 406. For example, the initial tooth position 404 is the position of the tooth 402 upon which the parameters for the orthodontic appliance 412 are calculated. The goal of treatment is to move the tooth 402 from the initial tooth position 404 to the final tooth position 406.

As can be seen in FIG. 4, the archwire 420 passes through an archwire slot of the orthodontic appliance 412. Because the initial tooth position 404 for the tooth 402 depicted in FIG. 4 is maloccluded, the archwire 420 exhibits a deformation as it passes through the archwire slot. That is, the archwire 420 must deform to pass through the archwire slot of the orthodontic appliance 412. Because the archwire 420 is elastic, this deformation causes a force to be applied to the tooth 402 by the archwire 420 via the orthodontic appliance 412. More specifically, the archwire 420 contacts, and applies force to, the boundaries of the archwire slot. When the tooth 402 is in its final tooth position 406, the archwire 420 passes smoothly through the archwire slot of the orthodontic appliance 412 (i.e., the archwire 420 need not deform to pass through the archwire slot of the orthodontic appliance 412). Because the archwire 420 passes through the archwire slot of the orthodontic appliance 412 without deforming when the tooth 402 is in the final tooth position 406, the archwire 420 passively interacts within the archwire slot. Because the interaction between the archwire 420 and the archwire slot is passive when the tooth 402 is in the final tooth position 406, the archwire 420 does not provide sufficient force to move the tooth 402 when the tooth 402 is in the final tooth position 406. To achieve this result, parameters for the orthodontic appliance 412 are calculated such that the archwire 420 passively interacts with the archwire slot of the orthodontic appliance 412 when the tooth 402 is in the final tooth position 406.

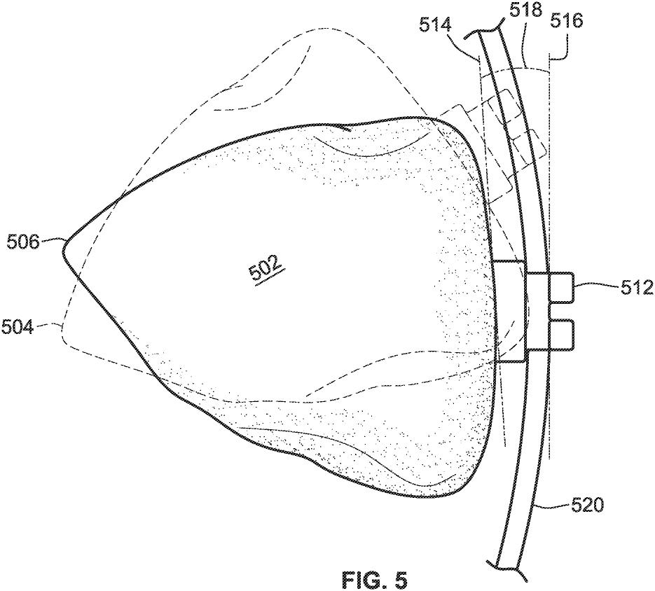

FIG. 5 depicts a positional relationship between a tooth 502 and an offset angle 518, according to some embodiments. For purposes of this discussion, the offset angle 518 is defined as the angle between the tooth surface 514 and the archwire plane 516 when viewed from the crown long axis. FIG. 5 depicts the tooth 502 in two positions: 1) an initial tooth position 504; and 2) a final tooth position 506. The initial tooth position 504 indicates the position of the tooth 502 before treatment (or at the time of calculation of parameters for the orthodontic appliance 512). The final tooth position 506 indicates the desired and/or planned position of the tooth 502 at the completion of treatment (or a current stage of treatment). In FIG. 5, the tooth 502 and orthodontic appliance 512 are shown with dashed lines to indicate the initial tooth position 504 and solid lines to indicate the final tooth position 506. For example, the initial tooth position 504 is the position of the tooth 502 upon which the parameters for the orthodontic appliance 512 are calculated. The goal of treatment is to move the tooth 502 from the initial tooth position 504 to the final tooth position 506.

As can be seen in FIG. 5, the archwire 520 passes through an archwire slot of the orthodontic appliance 512. Because the initial tooth position 504 for the tooth 502 depicted in FIG. 5 is maloccluded, the archwire 520 exhibits a deformation as it passes through the archwire slot. That is, the archwire 520 must deform to pass through the archwire slot of the orthodontic appliance 512. Because the archwire 520 is elastic, this deformation causes a force to be applied to the tooth 502 by the archwire 520 via the orthodontic appliance 512. More specifically, the archwire 520 contacts, and applies force to, the boundaries of the archwire slot. When the tooth 502 is in its final tooth position 506, the archwire 520 passes smoothly through the archwire slot of the orthodontic appliance 512 (i.e., the archwire 520 need not deform to pass through the archwire slot of the orthodontic appliance 512). Because the archwire 520 passes through the archwire slot of the orthodontic appliance 512 without deforming when the tooth 502 is in the final tooth position 506, the archwire 520 passively interacts within the archwire slot. Because the interaction between the archwire 520 and the archwire slot is passive when the tooth 502 is in the final tooth position 506, the archwire 520 does not provide sufficient force to move the tooth 502 when the tooth 502 is in the final tooth position 506. To achieve this result, parameters for the orthodontic appliance 512 are calculated such that the archwire 520 passively interacts with the archwire slot of the orthodontic appliance 512 when the tooth 502 is in the final tooth position 506.

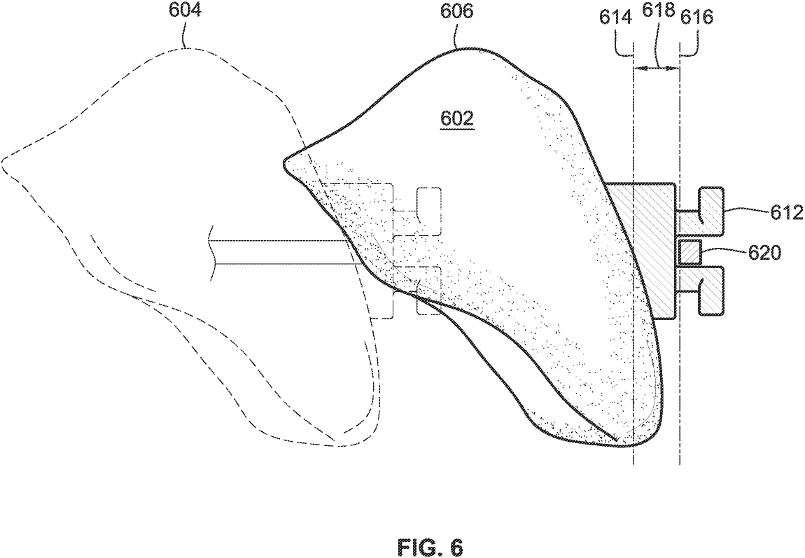

FIG. 6 depicts a positional relationship between a tooth 602 and an in/out distance 618, according to some embodiments. For purposes of this discussion, the in/out distance 618 is defined as the distance between the tooth surface 614 and the archwire plane 616. FIG. 6 depicts the tooth 602 in two positions: 1) an initial tooth position 604; and 2) a final tooth position 606. The initial tooth position 604 indicates the position of the tooth 602 before treatment (or at the time of calculation of parameters for the orthodontic appliance 612). The final tooth position 606 indicates the desired and/or planned position of the tooth 602 at the completion of treatment (or a current stage of treatment). In FIG. 6, the tooth 602 and orthodontic appliance 612 are shown with dashed lines to indicate the initial tooth position 604 and solid lines to indicate the final tooth position 606. For example, the initial tooth position 604 is the position of the tooth 602 upon which the parameters for the orthodontic appliance 612 are calculated. The goal of treatment is to move the tooth 602 from the initial tooth position 604 to the final tooth position 606.

As can be seen in FIG. 6, the archwire 620 passes through an archwire slot of the orthodontic appliance 612. Because the initial tooth position 604 for the tooth 602 depicted in FIG. 6 is maloccluded, the archwire 620 exhibits a deformation as it passes through the archwire slot. That is, the archwire 620 must deform to pass through the archwire slot of the orthodontic appliance 612. Because the archwire 620 is elastic, this deformation causes a force to be applied to the tooth 602 by the archwire 620 via the orthodontic appliance 612. More specifically, the archwire 620 contacts, and applies force to, the boundaries of the archwire slot. When the tooth 602 is in its final tooth position 606, the archwire 620 passes smoothly through the archwire slot of the orthodontic appliance 612 (i.e., the archwire 620 need not deform to pass through the archwire slot of the orthodontic appliance 612). Because the archwire 620 passes through the archwire slot of the orthodontic appliance 612 without deforming when the tooth 602 is in the final tooth position 606, the archwire 620 passively interacts within the archwire slot. Because the interaction between the archwire 620 and the archwire slot is passive when the tooth 602 is in the final tooth position 606, the archwire 620 does not provide sufficient force to move the tooth 602 when the tooth 602 is in the final tooth position 606. To achieve this result, parameters for the orthodontic appliance 612 are calculated such that the archwire 620 passively interacts with the archwire slot of the orthodontic appliance 612 when the tooth 602 is in the final tooth position 606.

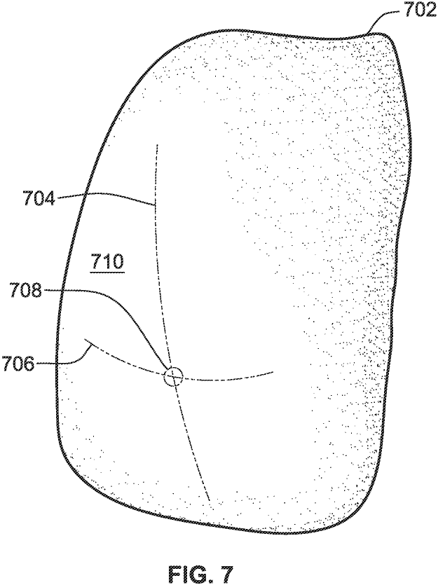

While the discussion of FIGS. 3 - 6 provide additional detail calculating parameters for an orthodontic appliance based on a variety of values associated with the patient’s mouth, the discussion of FIG. 7 provides additional detail regarding the geometry of a patient’s tooth.

FIG. 7 depicts determination of multiple base radii of a tooth 702, according to some embodiments. Typically, orthodontic appliances are bonded at a facial axis (FA) point 708 of the tooth 702. The FA point 708 is the location at which the mesial-distal (M-D) radius 706 and occlusal-gingival (O-G) radius 704 intersect on a facial surface 710 of the tooth 702. Typically, orthodontic appliances are bonded at the FA point 708 of the tooth 702, and prescriptions are calculated based on the orthodontic appliances being bonded at FA points of the teeth. For example, the orthodontic appliance may be centered, or otherwise placed over, the FA point 708 when the orthodontic appliance is bonded to the tooth 702. However, using systems, methods, and apparatuses described herein to create a custom orthodontic appliance, bonding the orthodontic appliance at the FA point 708 is not required.

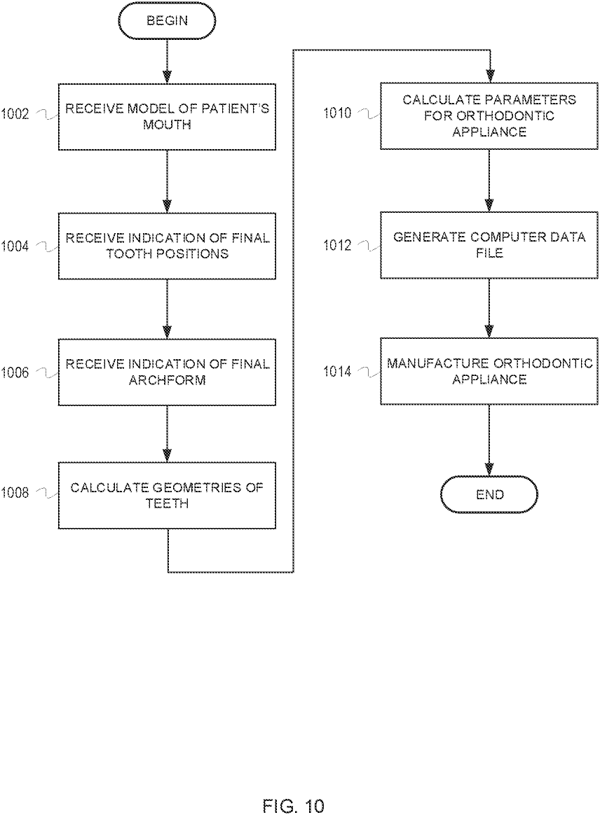

For some patient’s it may be difficult, if not impossible, to bond an orthodontic appliance at the FA point 708 of the tooth 702. For example, one or more of the patient’s teeth may overlap such that the FA point 708 of the tooth 702 is completely, or partially, blocked. For example, an area of the tooth 702 adjacent to the FA point 708 (e.g., where a portion of the bonding surface of the orthodontic appliance would be located) may be covered by another tooth. When this happens, the clinician may not have access to the FA point 708 or there may not be sufficient space on the facial surface 710 of the tooth 702 to bond the orthodontic appliance at the FA point 708 of the tooth 702. With the systems, methods, and apparatuses disclosed herein, a custom orthodontic appliance can be created to account for the positioning of the orthodontic appliance at a location other than the FA point 708 of the tooth 702. For example, the geometry of the orthodontic appliance can be designed such that forces equivalent, or similar, to those of a non-custom orthodontic appliance bonded to the tooth 702 at the FA point 708 can be achieved. This can be achieved, for example, by modifying the archwire slot (e.g., adjusting the location, shape, angle, etc. of the archwire slot). As one example, and discussed in more detail with respect to FIG. 10, the radii of the tooth 702 can be calculated to create an appropriate bonding surface for the orthodontic appliance and/or position the archwire slot of the orthodontic appliance. Accordingly, using the systems, methods, and apparatuses described herein, a custom orthodontic appliance can be designed and/or created that does not require bonding at, or near, the FA point 708 of the tooth 702. It should be noted that, in some embodiments, a clinician may prefer to bond an orthodontic appliance on a lingual surface of the tooth 702. In such embodiments, the geometry of the tooth 702 with respect to the lingual surface of the tooth 702 can be calculated to design and/or create a custom orthodontic appliance that can be bonded to the lingual surface of the tooth 702.

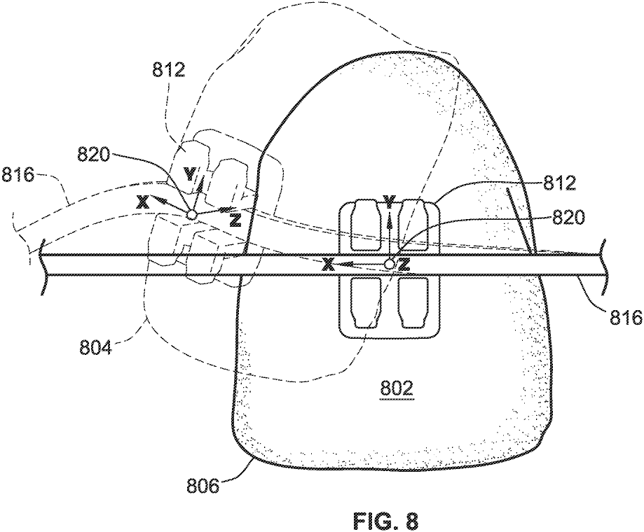

FIG. 8 depicts a patients tooth 802 in an initial tooth position 804 and a final tooth position 806, according to some embodiments. While FIGS. 3 - 6 depict single aspects of a malocclusion (i.e., tip angle, torque angle, offset angle, and in/out distance), FIG. 8 depicts a maloccluded tooth that is maloccluded in one or more aspects. FIG. 8 depicts the tooth 802 in both the initial tooth position 804 and the final tooth position 806. In FIG. 8, the tooth 802, orthodontic appliance 812, and archwire 816 are depicted with dashed lines to indicate the initial tooth position 804 and solid lines to indicate the final tooth position 806. An axis 820 is depicted with respect to both the initial tooth position 804 and in the final tooth position 806 to aid in visualizing the movement of the tooth 802 from the initial tooth position 804 to the final tooth position 806. As can be seen in FIG. 8, the archwire 816 is deformed when the tooth 802 is in the initial tooth position 804. Because the archwire 816 is elastic, it applies a force to the tooth 802 via the orthodontic appliance 812 to urge the tooth 802 from the initial tooth position 804 to the final tooth position 806. Parameters for the orthodontic appliance 812 are calculated based on the initial tooth position 804 and/or the final tooth position 806 such that when the tooth 802 is in the final tooth position 806, the archwire 816 passively interacts with an archwire slot of the orthodontic appliance 812.

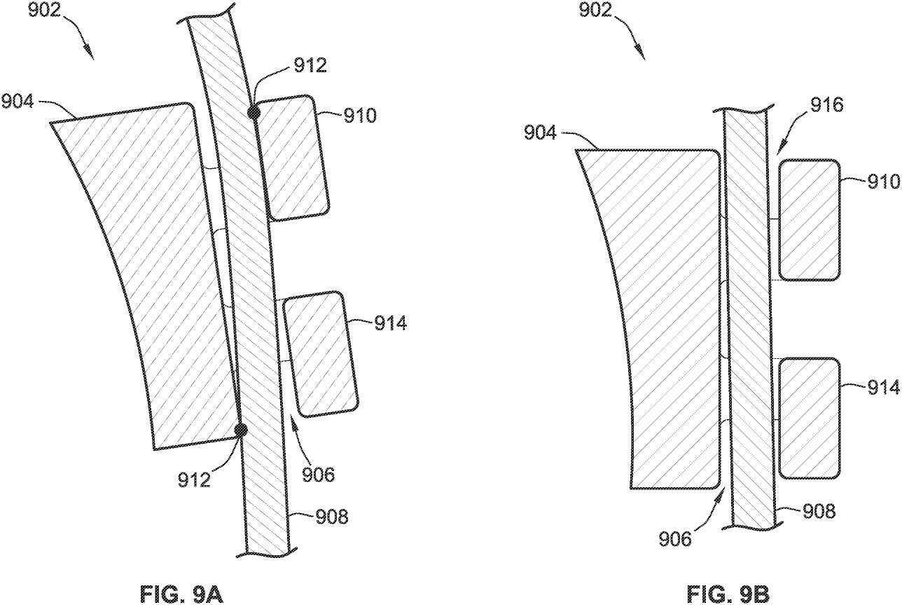

While the discussion of FIGS. 3 - 8 provide additional detail regarding the calculation of parameters for an orthodontic appliance, the discussion of FIGS. 9 provides additional detail regarding the interaction of an archwire within an archwire slot.

FIG. 9A depicts an archwire 908 actively interacting with an archwire slot 906 of an orthodontic appliance 902 and FIG. 9B depicts an archwire 908 passively interacting with an archwire slot 906 of an orthodontic appliance 902, according to some embodiments. As shown in FIG. 9A, an archwire 908 is passing through an archwire slot 906 of an orthodontic appliance 902. The orthodontic appliance 902 includes a base 904 and a body 916 (i.e., the portion of the orthodontic appliance 902 other than the base). The archwire slot 906 is formed within the body 916 of the orthodontic appliance 902 and can have boundaries defined by one or both of the body 916 and the base 904 of the orthodontic appliance 902.

In FIG. 9A, the archwire 908 is actively interacting within the archwire slot 906. For example, the archwire 908 actively interacts within the archwire slot 906 by contacting one or more boundaries of the archwire slot 906. As depicted in FIG. 9A, the archwire 908 is contacting boundaries of the archwire slot 906 at points 912. The archwire 908 is contacting the boundaries of the archwire slot 906, for example, because a tooth to which the orthodontic appliance 902 is bonded is maloccluded. This malocclusion causes the archwire 908 deform. Because the archwire 908 is elastic, it has the tendency to return to its non-deformed shaped. This tendency causes the archwire 908 to exert a force on the orthodontic appliance 902 via the archwire slot 906. Ultimately, the force the archwire 908 exerts on the orthodontic appliance 902 is transmitted to the tooth to which the orthodontic appliance 904 is bonded, resulting in movement of the tooth. Returning to the examples provided above, the interaction of the archwire 908 within the archwire slot 906 occurs when the tooth is in an initial (or non-final) position.

In FIG. 9B, the archwire 908 is passively interacting within the archwire slot 906. For example, the archwire 908 can passively interact within the archwire slot 906 by not contacting, or only minimally contacting, boundaries of the archwire slot 906. In one embodiment, the archwire 908 passively interacts within the archwire slot 906 as the archwire does not exert a clinically significant force on the orthodontic appliance 902 and/or tooth. As depicted in FIG. 9B, the archwire 908 is not, or is minimally, contacting the boundaries of the archwire slot 906. That is, between FIGS. 9A and 9B, the archwire has exerted a force on the orthodontic appliance 902 to move the tooth from an initial (or non-final) tooth position in FIG. 9A to a final tooth position in FIG. 9B.

While the discussion of FIGS. 1 - 9 describe an orthodontic appliance in which an archwire passively interacts within an archwire slot of the orthodontic appliance when the tooth is in its final tooth position, the discussion of FIGS. 10 - 11 provides additional detail regarding creating such orthodontic appliances.

FIG. 10 is a first flowchart depicting example operations for creating an orthodontic appliance, according to some embodiments. The flow beings at block 1002.

At block 1002, a model of a patient’s mouth is received. For example, a control circuit can receive the model of the patient’s mouth. The model of the patient’s mouth can take any suitable form. For example, the model can be a digital three-dimensional model, a physical three-dimensional model, a series of two-dimensional images, etc. As one example, the model of the patient’s mouth is based on a scan of the patient’s mouth. The flow continues at block 1004.

At block 1004, indications of final tooth positions are received. For example, the control circuit can receive the indications of the final tooth positions, The control circuit can receive the indication of the final tooth positions from an external device (i.e., a device other than the control circuit) and/or the control circuit. For example, the control circuit can receive the indications of the final tooth positions from a user device (e.g., a device used by a clinician). In such embodiments, the clinician may manually, and/or virtually, move the teeth in the patient’s mouth to the desired final tooth positions. Alternatively, a user (e.g., a clinician) can manipulate a physical model of the patient’s mouth to move the teeth (e.g., be physically moving the teeth in the physical model) to the desired final tooth positions. In either case, the user can segment the teeth (virtually and/or physically). That is, the user can separate the teeth such that each tooth (or group of teeth) is independent from others of the teeth. Further, in some embodiments, the control circuit can calculate and/or determine the final tooth positions. For example, the control circuit can, based on the model of the patient’s mouth, provide suggested final tooth positions. In such embodiments, the control circuit can provide the suggested final tooth positions using any suitable algorithm. Further, in embodiments in which the control circuit calculates and/or determines the final tooth positions, the control circuit can “receive” the indication of the final tooth positions from itself. The flow continues at block 1006.

At block 1006, an indication of a final archform is received. For example, the control circuit can receive the indication of the final archform. The control circuit can receive the indication of the final archform from an external device and/or the control circuit. For example, the control circuit can receive the indication of the final archform from a user device and/or receive the indication of the final archform from itself after it calculates/determines the final archform (based, for example, on the model of the patient’s mouth and/or the final tooth positions). The flow continues at block 1008.

At block 1008, geometries of the teeth in the patient’s mouth are calculated. For example, the control circuit can calculate the geometries of the teeth in the patient’s mouth. In one embodiment, the control circuit calculates a geometry of a facial surface of the patient’s tooth. For example, the geometry of the patient’s tooth is calculated for the portion of the facial surface of the patient’s tooth at which the orthodontic appliance will be bonded. In such embodiments, if the orthodontic appliance is to be bonded at an FA point of the patient’s tooth, the geometry of the tooth is calculated for the facial surface of the patient’s tooth around the FA point (e.g., the portion of the facial surface of the tooth that will be covered by a bonding surface of the orthodontic appliance). As another example, if the orthodontic appliance is to be bonded at a location on the patient’s tooth other than the FA point, the control circuit calculates the geometry of the patient’s tooth for the location at which the orthodontic appliance will be bonded. In some embodiments, the control circuit calculates the geometry of the tooth by calculating one or more radii of the tooth. Returning to the example of an orthodontic appliance to be bonded at the FA point of the facial surface of a tooth, the control circuit calculates the M-D radius and O-G radius to calculate the geometry of the patient’s tooth. Likewise, if the orthodontic appliance is to be bonded at a location other than the FA point of the facial surface of the tooth, the control circuit calculates radii associated with the intended or proposed location of the orthodontic appliance to calculate the geometry of the patient’s tooth. The flow continues at block 1010.

At block 1010, parameters for the orthodontic appliance are calculated. For example, the control circuit can calculate the parameters for the orthodontic appliance. The control circuit calculates the parameters for the orthodontic appliance based on the final tooth positions, the final archform, and/or geometries of the teeth in the patient’s mouth. In one embodiment, the parameters of the orthodontic appliance position an archwire slot of the orthodontic appliance such that an archwire passively interacts within the archwire slot with the teeth in the patient’s mouth are in the final tooth positions. That is, the control circuit designs a custom orthodontic appliance based on the patient’s malocclusions and/or facial geometry and the desired final tooth positions. In some embodiments, the final tooth position can be an “overcorrection,” such that the teeth are moved beyond their desired position. The parameters for the orthodontic appliance can include, for example, a slot width, a tip angulation, a torque angulation, an offset angulation, a mesial-distal width, an occlusal-gingival height, an in-out height, a mesial-distal base radius, an occlusal-gingival base radius, a type of hook, a presence of a hook, a location of a hook, and/or a location of the orthodontic appliance on a tooth in the patient’s mouth. The flow continues at block 1012.

At block 1012, a computer data file is generated. For example, the control circuit can generate the computer data file. The computer data file includes instructions to additively manufacture the orthodontic appliance. The flow continues at block 1014.

At block 1014, the orthodontic appliance is manufactured. For example, a manufacturing device manufactures the orthodontic appliance based on the computer data file. In one embodiment, the manufacturing device is an additive manufacturing device and the manufacturing device additively manufactures the orthodontic appliance.

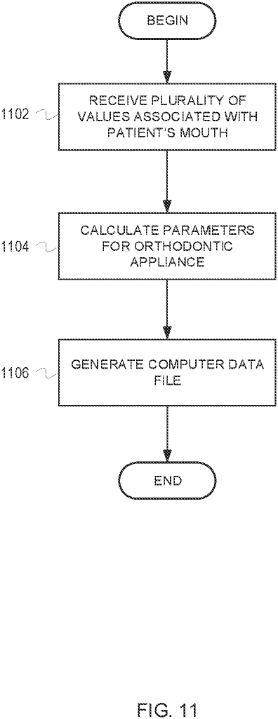

FIG. 11 is a second flowchart depicting example operations for creating an orthodontic appliance, according to some embodiments. The flow begins at block 1102.

At block 1102, a plurality of values associated with a patient’s mouth are received. For example, a control circuit can receive the plurality of parameters associated with the patient’s mouth. The parameters for the patient’s mouth can include any suitable parameters. For example, the parameters can include a slot width, a tip angulation, a torque angulation, an offset angulation, and/or an in-out height. The control circuit can receive the parameters associated with the patient’s mouth directly, or can calculate the parameters associated with the patient’s mouth. For example, if the parameters associated with the patient’s mouth are received directly by the control circuit, an external device (e.g., a user device) can provide the parameters associated with the patient’s mouth to the control circuit. As another example, the control circuit can calculate the parameters associated with a patient’s mouth based on a scan, or other data, associated with the patient’s mouth. The flow continues at block 1104.

At block 1104, parameters for an orthodontic appliance are calculated. For example, the control circuit can calculate the parameters for the orthodontic appliance. In one embodiment, the control circuit calculates the parameters for the orthodontic appliance based on the values associated with the patient’s mouth. In one embodiment, the parameters of the orthodontic appliance position an archwire slot of the orthodontic appliance such that an archwire passively interacts within the archwire slot with the teeth in the patient’s mouth are in the final tooth positions. That is, the control circuit designs a custom orthodontic appliance based on the patient’s malocclusions and/or facial geometry and the desired final tooth positions. In some embodiments, the final tooth position can be an “overcorrection,” such that the teeth are moved beyond their desired position. The parameters for the orthodontic appliance can include, for example, a slot width, a tip angulation, a torque angulation, an offset angulation, a mesial-distal width, an occlusal-gingival height, an in-out height, a mesial-distal base radius, an occlusal-gingival base radius, a type of hook, a presence of a hook, a location of a hook, and/or a location of the orthodontic appliance on a tooth in the patient’s mouth. The flow continues at block 1106.

At block 1106, a computer data file is generated. For example, the control circuit can generate the computer data file. The computer data file includes instructions to additively manufacture the orthodontic appliance.

While the discussion of FIGS. 1 - 11 describes systems, methods, and apparatuses for creating custom orthodontic appliances, the discussion of FIGS. 12 - 20 describes systems, methods, and apparatuses for creating orthodontic appliance assemblies.

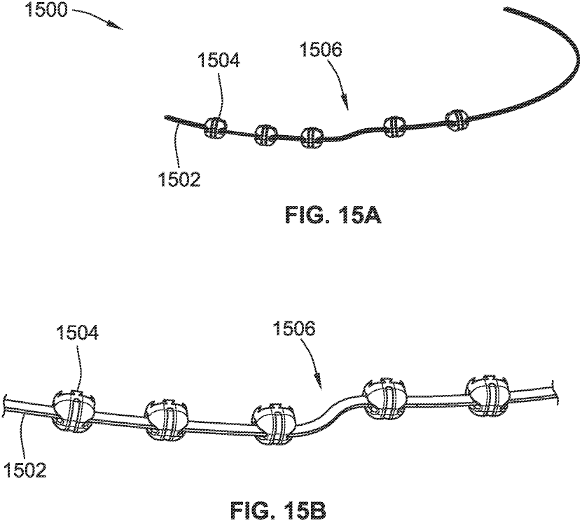

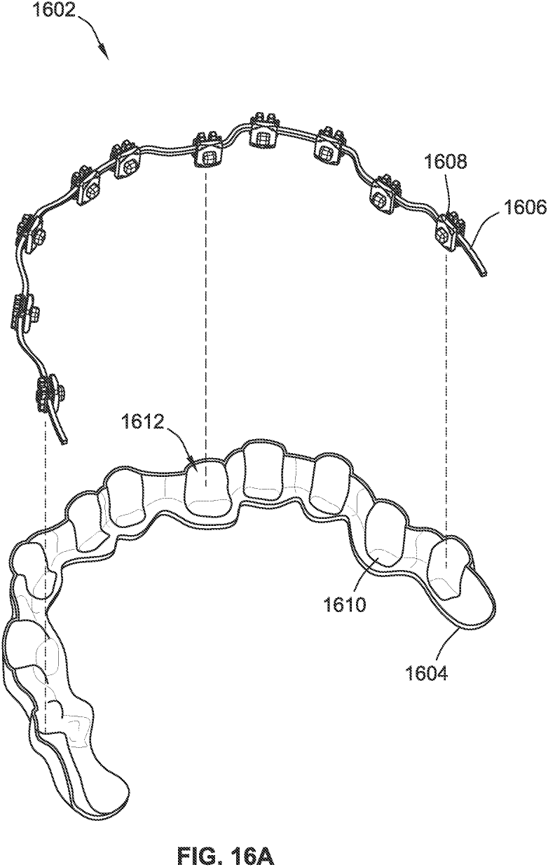

FIGS. 12A and 12B depict a dentition of a patient and an orthodontic appliance assembly 1200, according to some embodiments. The orthodontic appliance assembly 1200 includes orthodontic appliances 1206 and an archwire 1204. The orthodontic appliances 1206 include archwire slots (shown, and discussed in more detail with respect to, FIG. 14A). The orthodontic appliances 1206 can be of any suitable type. For example, the orthodontic appliances 1206 can be brackets, molar tubes, buccal tubes, Class II correctors, Class III correctors, auxiliaries, etc. Additionally, the orthodontic appliance assembly 1200 can include more than one type of orthodontic appliances and any variety and/or combination of types of orthodontic appliances. For example, the orthodontic appliance assembly 1200 can include brackets, molar tubes, and buccal tubes. The archwire 1204 can be of any suitable type. For example, the archwire 1204 can have any desired width, length, thickness, curvature, cross sections, etc.

The orthodontic appliances 1206 are configured to be bonded (e.g., secured, affixed, etc.) to teeth 1202 in the patient’s mouth. For example, the orthodontic appliances 1206 can be bonded to the teeth 1202 in the patient’s mouth via a bonding material (e.g., an adhesive, cement, glue, resin, etc.). As depicted in FIG. 1B, the orthodontic appliance assembly 1200 is assembled before use in the patient’s mouth. That is, the orthodontic appliances 1206 are retained on the archwire 1204 before some, or all, of the orthodontic appliances 1206 are bonded to the teeth 1202 in the patient’s mouth. In some embodiments, it is possible to retain the orthodontic appliances 1206 on the archwire 1204 before some, or all, of the orthodontic appliances 1206 are bonded to the teeth 1202 in the patient’s mouth because some, or all, of the orthodontic appliances 1206 are custom orthodontic appliances, as described with respect to FIGS. 1 - 11.

The orthodontic appliances 1206 can be retained on the archwire in any suitable manner and to any desired degree. That is, the orthodontic appliances 1206 can be freely and/or securely retained on the archwire 1204. For example, in one form, the orthodontic appliances 1206 can be retained on the archwire 1204 by caps or other structures at the ends of the archwire 1204 to decease the likelihood that the orthodontic appliances 1206 fall off the archwire 1204 during manipulation of the orthodontic appliance assembly 1200. In such embodiments, the orthodontic appliances 1206 may be free to rotate and/or move about the archwire 1204 while the orthodontic appliances 1206 are retained on the archwire 1204 (i.e., the orthodontic appliances 1206 are freely retained on the archwire 1204). Though the orthodontic appliances 1206 may be free to rotate and/or move about the archwire 1204 while the orthodontic appliances 1204 are retained on the archwire 1204, because the orthodontic appliances 1206 are retained on the archwire 1204, a sequencing (or order) of the orthodontic appliances 1206 can be maintained.

In some embodiments, the orthodontic appliances 1206 can be securely retained on the archwire 1204. For example the orthodontic appliances 1206 can be securely retained on the archwire slot such that they have 1) specific orientations with respect to the archwire 1206 and/or 2) specific locations on the archwire 1204. It should be noted that, in some embodiments, the orthodontic appliances 1206 can be securely retained on the archwire such than only minor adjustment (e.g., to the orientation(s) and/or location(s) of the orthodontic appliance(s) 1206) are needed before the orthodontic appliance assembly 1200 can be placed in the patient’s mouth. Accordingly, though the orthodontic appliances 1206 are securely retained on the archwire 1204, they may be movably retained on the archwire 1204. The orthodontic appliances 1206 can be securely retained on the archwire 1204 by use of permanent stops and/or removable stops. The permanent stops can be structures and/or materials that are added to the archwire 1204 (e.g., rubber or plastics structures, wax, etc.) and/or integral with the archwire 1204 (e.g., detents, sections of the archwire 1204 with increased diameter, etc.). The removable stops can be structures and/or materials that are added to the archwire 1204 (e.g., rubber or plastic structures, wax, etc.). In some embodiments, the orthodontic appliances 1206 are retained on the archwire 1204 without any modifications to the archwire 1204. That is, in some embodiments, a traditional archwire 1204 with no modifications can be used for the orthodontic appliance assembly 1200. In such embodiments, any suitable mechanism can be used to retain the orthodontic appliances 1206 on the archwire 1204. For example, the orthodontic appliances 1206 can be retained on the archwire 1204 via elastic ligatures, metal ligatures, enclosed archwire slots, etc. As another example, in the case of self-ligating orthodontic appliances, the self-ligating orthodontic appliances can be retained on the archwire 1204 via their self-ligating mechanisms (e.g., doors, springs, clips, etc.).

Finally, it should be noted that any combination of the manner in which the orthodontic appliances 1206 are retained to the archwire 1204 and/or the degree to which the orthodontic appliances 1206 are retained on the archwire 1204 is contemplated. For example, a first group of the orthodontic appliances 1206 can be freely retained on the archwire 1204 via caps, a second group of the orthodontic appliances can be securely retained with respect to their orientations on the archwire 1204 via wax, a third group of orthodontic appliances can be securely retained with respect to their locations on the archwire via a feature of the archwire 1204, and a fourth group of orthodontic appliances 1206 can be securely retained with respect to their locations and orientations on the archwire 1204 via ligatures.

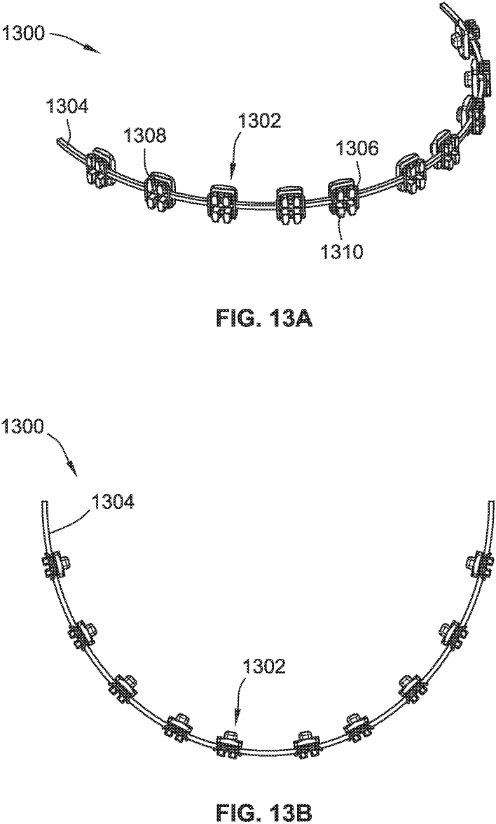

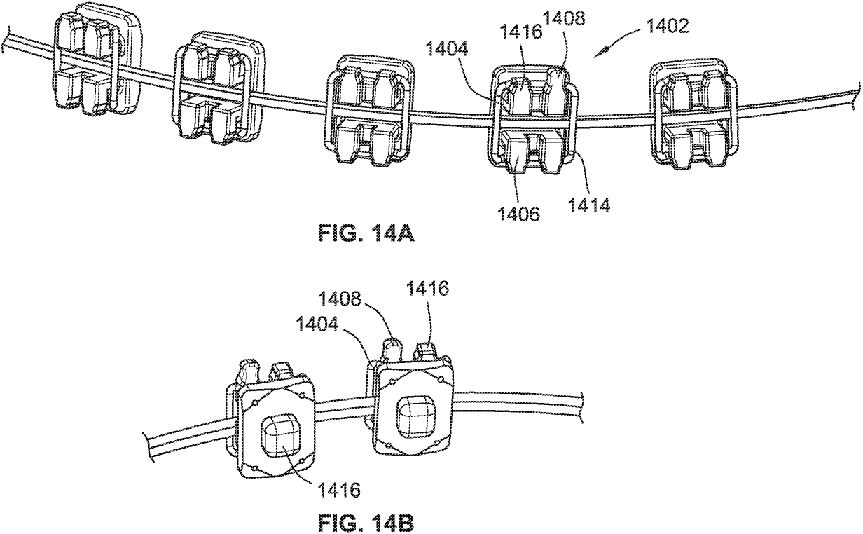

FIGS. 13A and 13B are perspective and top views, respectively, of an orthodontic appliance assembly 1300, according to some embodiments. The orthodontic appliance assembly 20 comprises an archwire 1304 and orthodontic appliances 1302. The orthodontic appliances can be of any suitable type and include any desired combination of orthodontic appliances. For example, in the example depicted in FIGS. 13A and 13B, some of the orthodontic appliances 1302 includes hooks 1308.

The orthodontic appliances 1302 include archwire slots. The archwire 1304 seats in the archwire slots of the orthodontic appliances 1302. The orthodontic appliances 1302 can be traditionally ligated orthodontic appliances and/or self-ligating orthodontic appliances. For example, as depicted in FIGS. 13A and 13B, the orthodontic appliances 1302 are traditional orthodontic appliances. Accordingly, the orthodontic appliances 1300 include tie wings 1310. Ligatures 1306 are wrapped about the tie wings 1310 to secure the archwire 1304 in the archwire slots of the orthodontic appliances 1302. That is, the orthodontic appliances 1300 are retained on the archwire 1304 with the ligatures 1306 via the archwire slots. In the case of self-ligating orthodontic appliances (i.e., active and passive self-ligating orthodontic appliances), the archwire 1304 can be secured within the archwire slots via the self-ligating mechanisms of the orthodontic appliances 1302.

In some embodiments, the orthodontic appliance assembly 1300 is assembled before the orthodontic appliances 1302 are secured to teeth in a patient’s mouth. That is, the archwire 1304 is secured in the archwire slots such that the orthodontic appliances 1302 are retained on the archwire 1304 before the orthodontic appliance assembly 1300 is placed in the patient’s mouth.

While the discussion of FIGS. 12A - 12B and 13 provides an overview of orthodontic appliances assemblies, the discussion of FIGS. 14A and 14B provides additional detail regarding orthodontic appliance assemblies.

FIGS. 14A and 14B are exploded facial and lingual views, respectively, of an orthodontic appliance assembly, according to some embodiments. The orthodontic appliance assembly comprises an archwire 1410 and orthodontic appliances 1402. Though depicted as traditional orthodontic appliances in FIGS. 14A and 14B, such is not required. For example, in some embodiments, some or all of the orthodontic appliances 1402 can be self-ligating orthodontic appliances. Additionally, though depicted as brackets in FIGS. 14A and 14B, the orthodontic appliances 1402 can be of any suitable type (molar tubes, buccal tubes, Class II correctors, Class III correctors, auxiliaries, etc.).

The orthodontic appliances 1402 have facial surfaces 1416 and bonding surfaces 1412. The facial surfaces 1416 on the outer side of the orthodontic appliances 1402 and the bonding surfaces 1412 are on the lingual side of the orthodontic appliances. The orthodontic appliances 1402 include archwire slots 1414 in their facial surfaces 1416. The archwire slots 1414 are configured to receive the archwire 1410. The orthodontic appliances 1402 are retained on the archwire 1410 via the archwire slots 1414. The orthodontic appliances 1402 depicted in FIGS. 14A and 14B are traditional orthodontic appliances. Accordingly, the orthodontic appliances 1402 are secured to the archwire 1410 via ligatures 1404. The ligatures wrap about tie wings 1406 of the orthodontic appliances 1402. In embodiments including traditional orthodontic appliances, the ligatures 1404 can retain the orthodontic appliances 1402 on the archwire 1410. For example, the ligatures 1404 can freely and/or securely retain the orthodontic appliances 1402 on the archwire 1410. In some embodiments, the ligatures 1404 retain the orthodontic appliances 1402 on the archwire 1410 in concert with additional components and/or features of the archwire 1410. For example, the ligatures 1404 may work in concert with detents, clips, fasteners, etc. to retain the orthodontic appliances 1402 on the archwire 1410.

The bonding surfaces 1412 are configured to be bonded to the teeth in the patient’s mouth. Accordingly, the bonding surfaces 1412 can have any suitable geometry. For example, the bonding surfaces 1412 can have complex curvatures, as described in U.S. Patent Appl. No. 16/875,618 titled SYSTEMS AND METHODS FO MANUFACTURE OF ORTHODONTIC APPLIANCES filed May 15, 13020 and incorporated by reference herein in its entirety. In some embodiments, the orthodontic appliance assembly includes bonding material 1416. The bonding material 1416 is located on the bonding surfaces 1412 of some, or all, of the orthodontic appliances 1402. In such embodiments, the bonding material 1416 can be applied to the bonding surfaces 1412 of the orthodontic appliances 1402 before the orthodontic appliance assembly 300 is placed in the patient’s mouth.

While the discussion of FIGS. 14A and 14B provide additional detail regarding orthodontic appliance assemblies, the discussion of FIGS. 15A and 15B describe an orthodontic appliance assembly including a pre-bent archwire.

FIG. 15A is a perspective view, and FIG. 15B is an exploded perspective view, of an orthodontic appliance assembly 1500 including an archwire 1502 featuring a bend 1506, according to some embodiments. The orthodontic appliance assembly 1500 comprises the archwire 1502 and orthodontic appliances 1504. As depicted in FIGS. 15A and 15B, the orthodontic appliances 1504 are self-ligating orthodontic appliances. Accordingly, ligatures (or other fasteners) may not be needed to retain the orthodontic appliances 1504 on the archwire 1502. Instead, because the orthodontic appliances 1504 are self-ligating, the orthodontic appliances include self-ligating mechanisms (e.g., doors, springs, clips, etc.) that retain the orthodontic appliances 1504 on the archwire 1502.

As previously noted, the archwire 1502 features a bend. During the installation of braces, clinicians may find it desirable to bend the archwire 1502 to achieve certain tooth movement. Just as the orthodontic appliance assembly 1500 can be assembled (i.e., the orthodontic appliances 1504 can be installed on the archwire 1502) before use in a patient’s mouth, the archwire 1502 can be shaped (e.g., bent, rotated, or otherwise formed) before use of the orthodontic appliance assembly 1500 in the patient’s mouth. For example, as depicted in FIG. 4A and 4B, the archwire 1502 has been formed to include the bend 1506. The archwire 1502 can be shaped before, or after, the orthodontic appliances 1504 are retained on the archwire 1502 (i.e., the orthodontic appliance assembly 1500 is assembled).

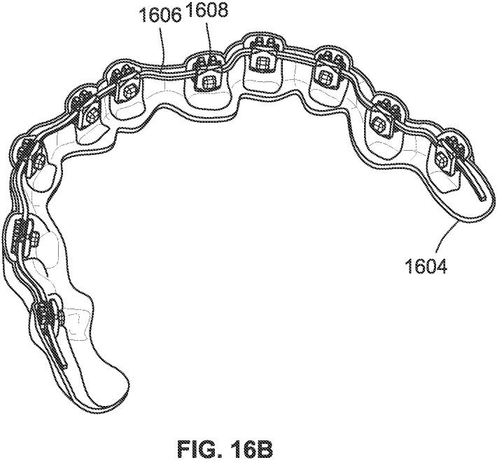

While the discussion of FIGS. 12 - 15 describes orthodontic appliance assemblies, the discussion of FIGS. 16A and 16B describes the use of an orthodontic appliance assembly with a bonding tray.

FIGS. 16A and 16B depict an orthodontic appliance assembly 1602 and a bonding tray 1604. The orthodontic appliance assembly 1602 includes orthodontic appliances 1608 and an archwire 1604. In one embodiment, the orthodontic appliances 1608 are retained on the archwire 1606 before the orthodontic appliance assembly 1602 is placed in a patient’s mouth (i.e., the orthodontic appliances 1608 are secured to teeth in the patient’s mouth).

The bonding tray 1604 can be used to indirectly bond (i.e., secure) the orthodontic appliances 1608 to the teeth in the patient’s mouth. In such embodiments, the bonding tray 1604 includes cavities 1610 that are configured to receive the patient’s teeth. The orthodontic appliance assembly 1602 is placed in the bonding tray 1604. The bonding tray 1604, with the orthodontic appliance assembly 1602 inserted, is placed in the patient’s mouth when the orthodontic appliances 1608 are secured to the patient’s teeth. In one embodiment, the geometry of the bonding tray 1604 is based on a scan of the patient’s mouth. The bonding tray 1604 includes pockets 1612. Each of the pockets 1612 is designed to receive one of the orthodontic appliances 1608. Accordingly, the pockets 1612 can take any suitable form. For example, the pockets 1612 can be shaped to match an associated one of the orthodontic appliances 1608. Additionally, in some embodiments, the orientation and/or location of the pockets 1612 corresponds to a location upon which an associated one of the orthodontic appliances 1608 is to be secured on the patient’s tooth. The bonding tray 1604 is shaped such that it does not interfere with the archwire 1606. That is, the orthodontic appliance assembly 1602, including the archwire 1606, can be placed in the bonding tray 1604.

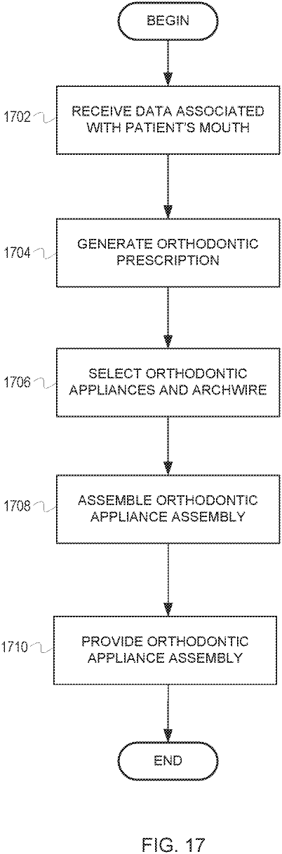

While the discussion of FIGS. 12 - 16 describes orthodontic appliance assemblies, the discussion of FIGS. 17 - 18 describes manufacture and assembly of such orthodontic appliance assemblies.

FIG. 17 is a flowchart depicting example operations for manufacturing an orthodontic appliance assembly, according to some embodiments. The flow begins at block 1702.

At block 1702, data associated with a patient’s mouth is received. For example, the data associated with the patient’s mouth can be received by a control circuit. The data associated with the patient’s mouth can include a scan of the patient’s mouth, measurements associated with the patient’s mouth, tooth positions for the patient’s mouth, tooth locations for the patient’s mouth, tooth orientations for the patient’s mouth, a diagram of the patient’s mouth, spatial data for the patient’s mouth, etc. The flow continues at block 1704.

At block 1704, an orthodontic prescription is generated for the patient’s mouth. The orthodontic prescription can be generated automatically (e.g., via software by a control circuit) and/or manually by a clinician. For example, a base prescription can be generated automatically and the clinician can modify the base prescription to form the orthodontic prescription. The orthodontic prescription is generated based on the data associated with the patient’s mouth. The flow continues at block 1706.

At block 1706, orthodontic appliances and an archwire are selected for the patient’s mouth. The orthodontic appliances and archwire can be selected automatically (e.g., as part of the prescription for the patient’s mouth) and/or manually by the clinician (e.g., the clinician can physically retrieve the orthodontic appliances and/or archwire). The flow continues at block 1708.

At block 1708, the orthodontic appliance assembly is assembled. For example, the orthodontic appliance assembly can be assembled automatically (e.g., robotically) and/or manually (e.g., by hand). The orthodontic appliance assembly is assembled by installing some, or all, of the orthodontic appliances on the archwire. For example, the orthodontic appliances can be installed on the archwire by retaining the orthodontic appliances on the archwire via ligatures and/or self-ligating mechanisms. In some embodiments, the orthodontic appliances are oriented and/or oriented before, or during, assembly of the orthodontic appliance assembly. The orthodontic appliances can be oriented simply to ensure that the bonding surfaces and facial surfaces of the orthodontic appliances are consistent with the curvature of the archwire. In some embodiments, however, one or more of the orthodontic appliances are oriented such that they should require little or no manipulation before the orthodontic appliance assembly is placed in the patient’s mouth. Likewise, the orthodontic appliances can be sequenced such that the orthodontic appliances are in the correct order for the patient’s mouth. In some embodiments, the orienting and/or sequencing of the orthodontic appliances is based on the orthodontic prescription. The flow continues at block 1710.

At block 1710, the orthodontic appliance assembly is provided. For example, the orthodontic appliance assembly can be provided for placement in the patient’s mouth.

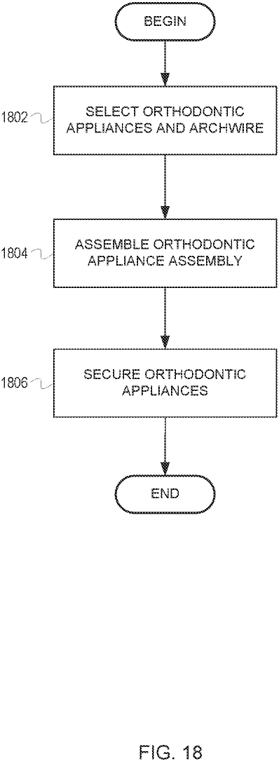

While the discussion of FIG. 17 describes the manufacture of orthodontic appliance assemblies, the discussion of FIG. 18 provides additional detail regarding the assembly of orthodontic appliance assemblies.

FIG. 18 is a flowchart depicting example operations for assembling an orthodontic appliance assembly, according to some embodiments. The flow begins at block 1802.

At block 1802, orthodontic appliances and an archwire are selected. The orthodontic appliances and archwire can be selected automatically (e.g., as part of the prescription for the patient’s mouth) and/or manually by the clinician (e.g., the clinician can physically retrieve the orthodontic appliances and/or archwire). The flow continues at block 1804.

At block 1804, the orthodontic appliance assembly is assembled. For example, the orthodontic appliance assembly can be assembled automatically (e.g., robotically) and/or manually (e.g., by hand). The orthodontic appliance assembly is assembled by installing some, or all, of the orthodontic appliances on the archwire. For example, the orthodontic appliances can be installed on the archwire by retaining the orthodontic appliances on the archwire via ligatures and/or self-ligating mechanisms. In some embodiments, the orthodontic appliances are oriented and/or oriented before, or during, assembly of the orthodontic appliance assembly. The orthodontic appliances can be oriented simply to ensure that the bonding surfaces and facial surfaces of the orthodontic appliances are consistent with the curvature of the archwire. In some embodiments, however, one or more of the orthodontic appliances are oriented such that they should require little or no manipulation before the orthodontic appliance assembly is placed in the patient’s mouth. Likewise, the orthodontic appliances can be sequenced such that the orthodontic appliances are in the correct order for the patient’s mouth. In some embodiments, the orienting and/or sequencing of the orthodontic appliances is based on the orthodontic prescription. The flow continues at block 1806.

At block 1806, the orthodontic appliances are secured to teeth in the patient’s mouth. For example, the orthodontic appliances can be secured to teeth in the patient’s mouth after the orthodontic appliance assembly has been assembled. The orthodontic appliances are secured to the teeth in the patient’s mouth via a bonding material (e.g., an adhesive, cement, glue, resin, etc.).

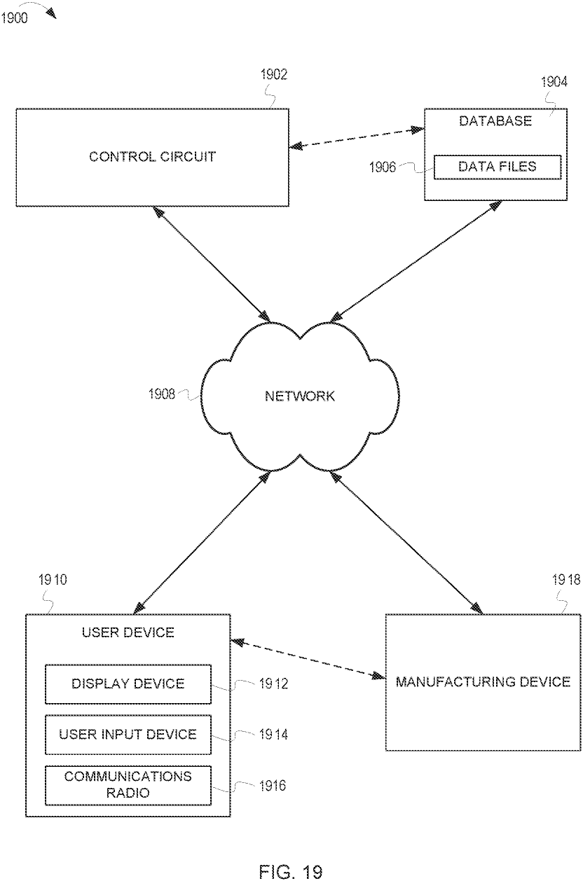

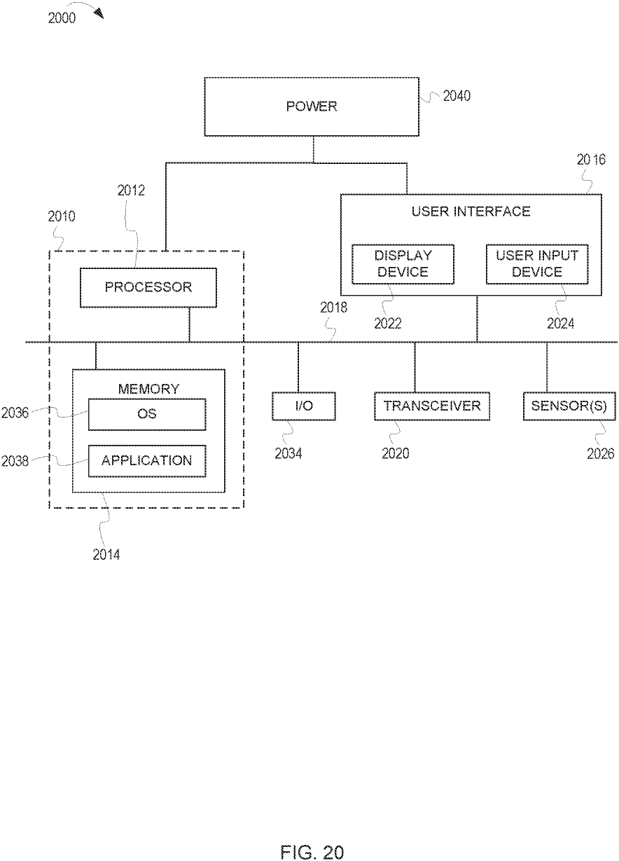

While the discussion of FIGS. 17 - 18 describe the manufacture and assembly of orthodontic appliance assemblies, the discussion of FIGS. 19 and 20 describes systems that can be used to create, assemble, and/or manufacture orthodontic appliances assemblies.

FIG. 19 is a block diagram is a block diagram of a system 1900 for additively manufacturing orthodontic appliances, according to some embodiments. The system 1900 includes a control circuit 1902, a database 1904, a user device 1910, and a manufacturing device 1918. One or more of the control circuit 1902, the database 1904, the user device 1910, and the manufacturing device 1918 are communicatively coupled via a network 1908. The network 1908 can include a local area network (LAN) and/or wide area network (WAN), such as the internet. Accordingly, the network 1908 can include wired and/or wireless links.

The user device 1910 can be any suitable type of computing device (e.g., a desktop or laptop computer, smartphone, tablet, etc.). The user device 1910 includes a display device 1912. The display device 1912 is configured to present a catalogue to a user. The catalogue includes orthodontic appliances that the user can obtain via the system 1900. For example, the catalogue can include all orthodontic devices that the user can purchase and/or manufacture via the manufacturing device 1918. The user interacts with the catalogue via a user input device 1914. The user can interact with the catalogue by navigating the catalogue, making selections from the catalogue, modifying orthodontic appliances included in the catalogue, etc. Accordingly, the user input device 1914 can be of any suitable type, such as a mouse, keyboard, trackpad, touchscreen, etc. The user device 1910 also includes a communications radio 1916. The communications radio 1916 transmits and receives information for the user device 1910. For example, in the case of a smartphone, the communications radio 1916 can be a cellular radio operating in accordance with the 4G LTE standard. Once a user has made a selection of an orthodontic appliance, the user device 1910, via the communications radio 1916 and the network 1908, transmits an indication of the selection to the control circuit 1902.

The control circuit 1902 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 1902 is configured (for example, by using corresponding programming as will be well understood by those skilled in the art) to carry out one or more of the steps, actions, and/or functions described herein.

By one optional approach the control circuit 1902 operably couples to a memory. The memory may be integral to the control circuit 1902 or can be physically discrete (in whole or in part) from the control circuit 1902 as desired. This memory can also be local with respect to the control circuit 1902 (where, for example, both share a common circuit board, chassis, power supply, and/or housing) or can be partially or wholly remote with respect to the control circuit 1902 (where, for example, the memory is physically located in another facility, metropolitan area, or even country as compared to the control circuit 1902).

This memory can serve, for example, to non-transitorily store the computer instructions that, when executed by the control circuit 1902, cause the control circuit 1902 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 1910 and/or the manufacturing device 1918. For example, the user device 1910 and the manufacturing device 1918 may be located in a clinician’s office (e.g., the user’s office) whereas the control circuit 1902, and possibly the database 1904, are cloud-based. The control circuit 1902 generally operates to retrieve data files 1906 based on the user’s selection of orthodontic appliances. The control circuit 1902 retrieves the data files 1906 from the database 1904. The database 1904 is configured to store the data files 1906. The data files 1906 are associated with orthodontic appliances. The data files 1906 are CAD files from which the orthodontic devices can be manufactured. The database 1904 stores a data file for each of the orthodontic appliances included in the catalogue. In one embodiment, the database 1904 stores a data file for all possible permutations of each orthodontic appliance (e.g., every possible modification and/or combination or modifications for each orthodontic appliance). The control circuit 1902 receives the indication of the orthodontic appliance and retrieves a data file based on the indication of the orthodontic appliance. In some embodiments, the control circuit 1902 can generate computer data files for the orthodontic appliances. For example, in the case of a custom orthodontic appliance, the control circuit can generate a computer data file that includes data necessary to additively manufacture the custom orthodontic appliance. Further, in some embodiments, the custom orthodontic appliances can be generated on a bonding tray, for example, such as the bonding trays described in U.S. Pat. Appl. No. 18/100,997 filed Jan. 24, 2023 titled ORTHODONTIC DEVICES AND METHODS OF USE, incorporated herein by reference in its entirety. In such embodiments, the control circuit 1902 can generate a computer data file including the data necessary to manufacture an orthodontic device. The orthodontic device comprises a bonding tray, one or more orthodontic appliances, and a plurality of support structures. The plurality of support structures connect the one or more orthodontic appliances to the bonding tray. For example, the plurality of support structures can comprise groups of support structures. Each group of support structures connects one of the orthodontic appliances to the bonding tray. In some embodiments, the plurality of orthodontic structures are designed to connect the one or more orthodontic appliances to the bonding tray at an orientation based on a model of the patient’s mouth (e.g., oriented appropriately for bonding the one or more orthodontic appliances to one or more teeth in the patient’s mouth).

It should be noted that the indication of the orthodontic appliance may include more than one orthodontic appliance. For example, the indication of the orthodontic appliance can include multiple orthodontic appliances, such as full set of brackets for a patient. Accordingly, the data file can be a file including instructions and/or specifications for multiple orthodontic appliances. For example, the data file may include multiple data files and/or multiple specifications for a number of brackets.

After retrieving the data file, the control circuit 1902 transmits the data file. In some embodiments, the control circuit 1902 encrypts or otherwise protects the data file before transmission. The control circuit 1902 can encrypt or otherwise protect the data file before transmission to prevent those other than the user from accessing the data file. Additionally, in some embodiments, the control circuit 1902 can encrypt or otherwise protect the data file to control the user’s access to the data file. For example, in some embodiments, the system is set up such that users pay on a per manufacture or per print basis. That is, the user does not purchase, and may not later have access to, the data file. Rather, the user purchases access to print or otherwise manufacture an orthodontic appliance based on the data file once (or other specified number of times).

Dependent upon the embodiment, the control circuit 1902 transmits the data file to the user device 1910, the manufacturing device 1918, or a third-party device (e.g., a laboratory capable of manufacturing the orthodontic appliance for the user). To whom, or to what, device the data file is transmitted may also aid in achieving access control. For example, in one embodiment, the control circuit 1902 transmits the data file directly to the manufacturing device 1918. Because the data file is not transmitted to the user device 1910, the data file may not be easily accessible by the user device 1910. Further, if an entity that controls the control circuit 1902 controls the manufacturing device 1918, access to files received by the manufacturing device 1918 may be further limited. In some embodiments, the control circuit 1902 transmits the data files to the user device 1910. In such embodiments, the user device 1910 transmits, via the communications radio (e.g., over a universal serial bus (USB) connection, wireless connection based on the 1902.11 standard, etc.), the data files to the manufacturing device 1918.

The manufacturing device 1918 additively manufacturers the orthodontic appliance(s) based on the data file. The manufacturing device 1918 can be of any suitable type, such as a 3D printer. The manufacturing device 1918 can be local to, or remote from, one or more of the control circuit 1902 and the user device 1910. For example, in one embodiment, the user device 1910 and the manufacturing device 1918 are located in the user’s office (i.e., the user device 1910 and the manufacturing device 1918 are local to one another). Alternatively, the manufacturing device 1918 may be located in a laboratory or some other facility that manufactures orthodontic appliances for the user.

FIG. 20 is a block diagram of a system 2000 that may be used for implementing any of the components, circuits, circuitry, systems, functionality, apparatuses, processes, or devices of the system 1900 of FIG. 19, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 2000 may be used to implement some or all of the control circuit, the database, the user device, the manufacturing device, and/or other such components, circuitry, functionality and/or devices. However, the use of the system 2000 or any portion thereof is certainly not required.

By way of example, the system 2000 may comprise a processor (e.g., a control circuit) 2012, memory 2014, and one or more communication links, paths, buses or the like 2018. Some embodiments may include one or more user interfaces 2016, and/or one or more internal and/or external power sources or supplies 2040. The processor 2012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 2012 can be part of control circuitry and/or a control system 2010, which may be implemented through one or more processors with access to one or more memory 2014 that can store commands, instructions, code and the like that is implemented by the control circuit and/or processors to implement intended functionality. In some applications, the control circuit and/or memory may be distributed over a communications network (e.g., LAN, WAN, the Internet) providing distributed and/or redundant processing and functionality. Again, the system 2000 may be used to implement one or more of the above or below, or parts of, components, circuits, systems, processes and the like.

In one embodiment, the memory 2014 stores data and executable code, such as an operating system 2036 and an application 2038. The application 2038 is configured to be executed by the system 2000 (e.g., by the processor 2012). The application 2038 can be a dedicated application (e.g., an application dedicated to orthodontic appliances, orthodontic appliance assemblies, the manufacture of orthodontic appliances and/or orthodontic appliance assemblies, selection of orthodontic appliances, etc.) and/or a general purpose application (e.g., a web browser, a retail application etc.). Additionally, though only a single instance of the application 2038 is depicted in FIG. 20, such is not required and the single instance of the application 2038 is shown in an effort not to obfuscate the figures. Accordingly, the application 2038 is representative of all types of applications resident on the system (e.g., software preinstalled by the manufacturer of the system, software installed by an end user, etc.). In one embodiment, the application 2038 operates in concert with the operating system 2036 when executed by the processor 2012 to cause actions to be performed by the system 2000. For example, with respect to the disclosure contained herein, execution of the application 2038 by the processor 2012 causes the system to perform actions consistent with the selection and/or manufacture of orthodontic appliances and/or orthodontic appliance assemblies as described herein.

The user interface 2016 can allow a user to interact with the system 2000 and receive information through the system. In some instances, the user interface 2016 includes a display device 2022 and/or one or more user input device 2024, such as buttons, touch screen, track ball, keyboard, mouse, etc., which can be part of or wired or wirelessly coupled with the system 2000. Typically, the system 2000 further includes one or more communication interfaces, ports, transceivers 2020 and the like allowing the system 2000 to communicate over a communication bus, a distributed computer and/or communication network (e.g., a local area network (LAN), wide area network (WAN) such as the Internet, etc.), communication link 2018, other networks or communication channels with other devices and/or other such communications or combination of two or more of such communication methods. Further the transceiver 2020 can be configured for wired, wireless, optical, fiber optical cable, satellite, or other such communication configurations or combinations of two or more of such communications. Some embodiments include one or more input/output (I/O) ports 2034 that allow one or more devices to couple with the system 2000. The I/O ports can be substantially any relevant port or combinations of ports, such as but not limited to USB, Ethernet, or other such ports. The I/O interface 2034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 2026 to provide information to the system and/or sensor information that is communicated to another component, such as the central control system, a delivery vehicle, etc. The sensors 2026 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 2000 comprises an example of a control and/or processor-based system with processor 2012. Again, the processor 2012 can be implemented through one or more processors, controllers, central processing units, logic, software and the like. Further, in some implementations the processor 2012 may provide multiprocessor functionality.

The memory 2014, which can be accessed by the processor 2012, typically includes one or more processor-readable and/or computer-readable media accessed by at least the control circuit, and can include volatile and/or nonvolatile media, such as RAM, ROM, EEPROM, flash memory and/or other memory technology. Further, the memory 2014 is shown as internal to the control system 2010; however, the memory 2014 can be internal, external or a combination of internal and external memory. Similarly, some, or all, of the memory 2014 can be internal, external or a combination of internal and external memory of the processor 2012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 2014 can store code, software, executables, scripts, data, content, lists, programming, programs, log or history data, user information, customer information, product information, and the like. While FIG. 20 illustrates the various components being coupled together via a bus, it is understood that the various components may actually be coupled to the control circuit and/or one or more other components directly.

In some embodiments, an orthodontic appliance assembly comprises a plurality of orthodontic appliances, wherein each of the plurality of orthodontic appliances includes an archwire slot, and wherein each of the plurality of orthodontic appliances is configured to be bonded to a tooth in a patient’s mouth, an archwire, wherein the plurality of orthodontic appliances are retained on the archwire via the archwire slots, wherein the plurality of orthodontic appliances are retained on the archwire before the orthodontic appliances are bonded to teeth in the patient’s mouth.

In some embodiments, an apparatus and a corresponding method performed by the apparatus, comprises receiving data associated with a patient’s mouth, generating, based on the data associated with the patient’s mouth, an orthodontic prescription for the patent’s mouth, selecting, based on the orthodontic prescription for the patient’s mouth, one or more orthodontic appliances and an archwire, assembling the orthodontic appliance assembly, wherein the orthodontic appliance assembly includes the one or more orthodontic appliances and the archwire, wherein the assembling the orthodontic appliance assembly comprises installing the one or more orthodontic appliances on the archwire before use of the orthodontic appliance in the patient’s mouth, and providing, for placement in the patient’s mouth, the orthodontic appliance assembly.

In some embodiments, an apparatus and a corresponding method performed by the apparatus, comprises selecting, for a patient’s mouth, one or more orthodontic appliances and an archwire, wherein each of the one or more orthodontic appliances includes an archwire slot configured to receive the archwire, assembling the orthodontic appliance assembly, wherein the orthodontic appliance assembly includes the one or more orthodontic appliances and the archwire, wherein the assembling the orthodontic appliance assembly comprises installing the archwire in the archwire slots of the one or more orthodontic appliances before use of the orthodontic appliance assembly in the patient’s mouth, and securing, to teeth in the patient’s mouth after the assembling the orthodontic appliance assembly, the one or more orthodontic appliances.

In some embodiments, an orthodontic system comprises an orthodontic appliance assembly comprising a plurality of orthodontic appliances, wherein each of the plurality of orthodontic appliances includes an archwire slot, and wherein each of the plurality of orthodontic appliances is configured to be bonded to a tooth in a patient’s mouth, an archwire, wherein the plurality of orthodontic appliances are retained on the archwire via the archwire slots, wherein the plurality of orthodontic appliances are retained on the archwire before the orthodontic appliances are bonded to teeth in the patient’s mouth, and a bonding tray, the bonding tray including receptacles for receiving at least one of the plurality of orthodontic appliances.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1–35. (canceled)

36. A system for creating customer orthodontic appliances, the system comprising:
a control circuit, wherein the control circuit is configured to:
receive a plurality of values associated with a patient’s mouth, wherein the plurality of values associated with the patient’s mouth includes a slot width, a tip angulation, a torque angulation, an offset angulation, and an in-out height;
calculate, based on the values associated with the patient’s mouth, parameters for an orthodontic appliance, wherein the parameters for the orthodontic appliance position an archwire slot of the orthodontic appliance such that an archwire passively interacts within the archwire slot when teeth in the patient’s mouth are in their final tooth positions; and
generate, based on the parameters for the orthodontic appliance, a computer data file, wherein the computer data file includes instructions to additively manufacture the orthodontic appliance.

37. The system of claim 36, wherein the orthodontic appliance includes a body and a base, and wherein the parameters for the orthodontic appliance define a geometry of the body of the orthodontic appliance on the base.

38. (canceled)

39. The system of claim 36, wherein the plurality of value associated with the patient’s mouth further include a mesial-distal base radius and an occlusal-gingival base radius, wherein the control circuit is further configured to:
calculate, based on at least the mesial-distal base radius and the occlusal-gingival base radius, parameters for a base of the orthodontic appliance, and wherein the generation of the computer data file is further based on the parameters for the base of the orthodontic appliance.

40. The system of claim 36, wherein the control circuit is further configured to: receive, a model of the patient’s mouth and an indication of the final tooth positions; and calculate, based on the model of the patient’s mouth and the indication of the final tooth positions, the plurality of values associated with the patient’s mouth.

41. (canceled)

42. The system of claim 40, wherein the control circuit is further configured to:
generate, based on the model of the patient’s mouth and the teeth in the patient’s mouth, the final tooth positions for the teeth in the patient’s mouth.

43. The system of claim 40, wherein the control circuit is further configured to:
generate, based on the model of the patient’s mouth and the teeth in the patient’s mouth, a final archform.

44–46. (canceled)

47. The system of claim 36, wherein the parameters include one or more of a slot width, a tip angulation, a torque angulation, an offset angulation, a mesial-distal width, an occlusal-gingival height, an in-out height, a mesial-distal base radius, an occlusal-gingival base radius, a type of hook, a presence of a hook, a location of a hook, and a location of the orthodontic appliance on a tooth in the patient’s mouth.

48–51. (canceled)

52. A method for creating custom orthodontic appliances, the method comprising:
receiving, by a control circuit, a plurality of values associated with a patient’s mouth, wherein the plurality of values associated with the patient’s mouth includes a slot width, a tip angulation, a torque angulation, an offset angulation, and an in-out height;
calculating, by the control circuit based on the values associated with the patient’s mouth, parameters for an orthodontic appliance, wherein the parameters for the orthodontic appliance position an archwire slot of the orthodontic appliance such that an archwire passively interacts within the archwire slot when teeth in the patient’s mouth are in their final tooth positions; and
generating, by the control circuit based on the parameters for the orthodontic appliance, a computer data file, wherein the computer data file includes instructions to additively manufacture the orthodontic appliance.

53. The method of claim 52, wherein the orthodontic appliance includes a body and a bonding surface, and wherein the parameters for the orthodontic appliance define a geometry of the body of the orthodontic appliance on the base.

54. (canceled)

55. The method of claim 52, wherein the plurality of value associated with the patient’s mouth further include a mesial-distal base radius and an occlusal-gingival base radius, the method further comprising:
calculating, by the control circuit based on at least the mesial-distal base radius and the occlusal-gingival base radius, parameters for a base of the orthodontic appliance, and wherein the generation of the computer data file is further based on the parameters for the base of the orthodontic appliance.

56. The method of claim 52, further comprising:
receiving, by the control circuit, a model of the patient’s mouth and an indication of the final tooth positions; and
calculating, by the control circuit based on the model of the patient’s mouth and the indication of the final tooth positions, the plurality of values associated with the patient’s mouth.

57. (canceled)

58. The method of claim 56, further comprising:
generating, by the control circuit based on the model of the patient’s mouth and the teeth in the patient’s mouth, the final tooth positions for the teeth in the patient’s mouth.

59. The method of claim 56, further comprising:
generating, by the control circuit based on the model of the patient’s mouth and the teeth in the patient’s mouth, a final archform.

60-62. (canceled)

63. The method of claim 52, wherein the parameters include one or more of a slot width, a tip angulation, a torque angulation, an offset angulation, a mesial-distal width, an occlusal-gingival height, an in-out height, a mesial-distal base radius, an occlusal-gingival base radius, a type of hook, a presence of a hook, a location of a hook, and a location of the orthodontic appliance on a tooth in the patient’s mouth.

64–67. (canceled)

68. A method for creating custom orthodontic appliances, the method comprising:
receiving, by a control circuit, a plurality of values associated with a patient’s mouth, wherein the plurality of values associated with the patient’s mouth includes a slot width, a tip angulation, a torque angulation, an offset angulation, and an in-out height;
calculating, by the control circuit based on the values associated with the patient’s mouth, parameters for an orthodontic appliance, wherein the parameters for the orthodontic appliance position an archwire slot of the orthodontic appliance such that an archwire passively interacts within the archwire slot when teeth in the patient’s mouth are in their final tooth positions; and
manufacturing, based on the parameters for the orthodontic appliance, the orthodontic appliance.

69. The method of claim 68, wherein the orthodontic appliance is additively manufactured.

70. The method of claim 68, wherein the orthodontic appliance is manufactured based on a computer data file, the method further comprising:
generating, based on the parameters for the orthodontic appliance, the computer data file, wherein the computer data file includes instructions to manufacture the orthodontic appliance.

71. The method of claim 68, wherein the parameters include one or more of a slot width, a tip angulation, a torque angulation, an offset angulation, a mesial-distal width, an occlusal-gingival height, an in-out height, a mesial-distal base radius, an occlusal-gingival base radius, a type of hook, a presence of a hook, a location of a hook, and a location of the orthodontic appliance on a tooth in the patient’s mouth.

72. (canceled)

73. The method of claim 68, wherein the orthodontic appliance is configured to be secured to one or a facial side of one of the teeth in the patient’s mouth and a lingual side of one of the teeth in the patient’s mouth.

74. The method of claim 68, wherein when the archwire passively interacts within the archwire slot the archwire is not exerting a clinically significant force on the orthodontic appliance.

75–100. (canceled)
